(19) United States
(12) Patent Application Publication
(10) Pub. No.: US 2026/0318409 A1
(43) Pub. Date: Oct. 15, 2026

(54) COMBINED TORQUE INTERVENTION DELAY FOR A VEHICLE

(71) Applicant: JAGUAR LAND ROVER LIMITED, Warwickshire (GB)

(72) Inventors: Olivier ROQUES, Whitley, Coventry, Warwickshire (GB); Romain LACROISILLE, Whitley, Coventry, Warwickshire (GB); Calum ALLARDYCE, Whitley, Coventry, Warwickshire (GB); William HARRISON, Whitley, Coventry, Warwickshire (GB)

(21) Appl. No.: 19/484,148

(22) PCT Filed: May 7, 2024
(86) PCT No.: PCT/EP2024/062622

§ 371 Date: Nov. 13, 2025

(30) Foreign Application Priority Data
May 15, 2023 (GB) 2307168.1

(51) Int. Cl. F16H 63/28; F16H 59/36; F16H 59/74; F16H 63/30

(52) U.S. Cl. CPC F16H 63/28; F16H 63/304; F16H 2059/366; F16H 59/74

(57) ABSTRACT

Aspects of the present invention relate to a control system (100), to a system, a vehicle (1), a method and to computer readable instructions. According to an aspect of the present invention there is provided a control system (100) for controlling a combined torque intervention of two actuators (24, 26) to a transmission system of a vehicle (1). The control system (100) comprising one or more processors (110), the one or more processors (110) collectively configured to: receive a gear change signal (165) that is indicative of a requirement to perform a gearshift. The one or more processors (110) are also configured receive one or more input parameters (166). The one or more processors (110) in dependence on the one or more input parameters (166), determine a timing delay (td) for a torque intervention signal that requests part of the combined torque intervention from a first one of the two actuators (24, 26). Then in dependence on the determined timing delay (td), the control system delays outputting of the torque intervention signal to improve alignment of the combined torque intervention from the two actuators (24, 26).

### TECHNICAL FIELD

The present disclosure relates to a combined torque intervention delay for a vehicle. Aspects of the invention relate to a control system, to a system, a vehicle, a method and to computer readable instructions.

### BACKGROUND

Automatic and automated gearshifts are used commonly in vehicles (such as hybrid vehicles, both Plug-in Hybrid Electric Vehicles (PHEV) and Mild Hybrid Electric Vehicles (MHEV)) and provide a number of benefits to the driver, for example increased vehicle performance, greater fuel efficiency, and relieving the need for the driver to change gears manually. In automatic transmission systems, it is known to provide torque modulation (or alternatively known as a torque intervention) during an automatic transmission shift (both for upshifts and downshifts) when the vehicle changes gears automatically. The torque intervention may be provided by an actuator, such as the engine or an electric machine.

However, when dealing with particularly fast shifts, such as when overtaking, or where changes in road conditions requires such a shift, there is the potential that more torque is required than a single actuator can provide. This may result in a slower shift than is expected and/or disrupt the smoothness of any acceleration or deceleration.

It is an aim of the present invention to address one or more of the disadvantages associated with the prior art.

### SUMMARY OF THE INVENTION

Aspects and embodiments of the invention provide a control system, to a system, a vehicle, a method and to computer readable instructions as claimed in the appended claims.

According to an aspect of the present invention there is provided a control system for controlling a combined torque intervention of two actuators to a transmission system of a vehicle. The control system comprising one or more processors, the one or more processors collectively configured to: receive a gear change signal that is indicative of a requirement to perform a gearshift; receive one or more input parameters; in dependence on the one or more input parameters, determine a timing delay for a torque intervention signal that requests part of the combined torque intervention from a first one of the two actuators; and in dependence on the determined timing delay, delay outputting of the torque intervention signal to improve alignment of the combined torque intervention from the two actuators.

A control system for controlling a combined torque intervention of two actuators to a transmission system of a vehicle, the control system comprising one or more processors, the one or more processors collectively configured to: receive a gear change signal that is indicative of a requirement to perform a gearshift and output a torque intervention signal that requests part of the combined torque intervention from a first one of the two actuators in response to the received gear change signal, wherein the one or more processors are further collectively configured to; receive one or more input parameters; in dependence on the one or more input parameters, determine a timing delay for the torque intervention signal; and in dependence on the determined timing delay, delay outputting of the torque intervention signal to improve alignment of the combined torque intervention from the two actuators.

The control system of the present invention enables a greater torque for gear shifts than would be feasible using a single actuator by synchronising the actuation of first and second actuators by taking into account certain actuator parameters. The ability to synchronise the actuators to execute a combined torque intervention by delaying the actuation of either the first actuator or second actuator using a timing delay, enables the execution of the torque intervention to be consistent at the input shaft side of the transmission.

The timing delay of the control system advantageously alleviates certain factors that could otherwise impact the driveability of the vehicle when shifting gears (automatic selection or manual selection in an automated system). For example, dependent upon vehicle architecture, the first actuator may be disposed in a first location and the one or more controllers may be disposed in a second location with a network connection between the two. The second actuator may be disposed in a third location potentially remote from either the first or second locations; again, with a network connection between the second actuator and the one or more controllers. The different location of the actuators in comparison to the controller(s) means that there is a network or other (e.g. mechanical) delay for the gear change signal to reach either of the two actuators if a torque request signal were sent from the controller(s) at the same time. As a result, the torque intervention request may reach the first actuator before the second actuator, or may otherwise cause the first actuator to deliver the torque intervention before the second actuator, or vice versa. The result would be a desync between the original request and the resultant torque intervention of the first and second actuator.

By delaying the request of, for example, the actuator that would provide a torque intervention soonest if both torque intervention requests were sent from the control system at the same time, the torque intervention will be delivered by a first actuator at a time substantially the same as the torque intervention of a second actuator. Therefore the combined torque intervention by the first and second actuators will happen together in a more synchronised manner delivering a smoother more refined gear shift.

The timing delay may take into consideration network delay in a requesting module and controlling module, programming time required to calculate required actuator settings to deliver the requested torque and finally physical delays in winding up sprung elements or shafts etc.

There is also provided a control system for controlling a combined torque intervention of two actuators to a transmission system of a vehicle. The control system comprising one or more processors, the one or more processors collectively configured to: receive one or more input parameters; in dependence on the one or more input parameters, determine a timing delay for a torque intervention signal that requests part of the combined torque intervention from a first one of the two actuators; and in dependence on the determined timing delay, delay outputting of the torque intervention signal to improve alignment of the combined torque intervention from the two actuators.

The same advantages of this additional control system are also present as described above in relation to the other control system.

The following embodiments may be applied to any of the previously described control systems.

In an embodiment, the timing delay is determined to cause the torque intervention from the two actuators to occur at substantially the same time. Optionally, the control system applies a timing delay to an output control signal which delays a torque intervention from an actuator. By synchronising the torque intervention of the first and second actuators the dual torque intervention of both components can be achieved at the same time, resulting in a smoother and more controllable gearshift. The timing delay counteracts any inherent delays between a torque intervention request being made from the other actuator and the requested torque being delivered. The delays may be from down-the-line components resulting from network delays, or physical delays for example where components wind up before actuation.

In an embodiment of the control system of the invention, substantially the same time means torque intervention from the two actuators occurs within 0.0001 to 0.1 seconds of each other. Preferably the actuation occurs within 0.001 to 0.1 seconds. More preferably the actuation occurs within 0.01 to 0.1 seconds.

In an embodiment of the control system of the invention, the one or more input parameters comprises a combined intervention request signal. Optionally, the combined intervention request signal is a signal that indicates to the control system that a combined torque intervention is required. The signal is a binary 0,1 signal which indicates respectively no combined torque intervention is require or a combined torque intervention is required. The use of a combined intervention signal in practice means that a combined intervention is not achieved for every gear change, rather only when there is a need for increased torque capability. Alternatively, it may be advantageous to utilise a combined intervention request of 1 for every gear change, for example in less powerful transmission systems such a scenario may be beneficial.

In an embodiment of the control system of the invention, the one or more input parameters comprises: a first actuator raw torque intervention request dependent at least upon a gear change signal; and second actuator raw torque intervention request dependent at least upon the gear change signal. Optionally, the type of gear shift (e.g. up/down) and magnitude of the gear shift is taken into consideration by the control system in order to determine the timing delay.

In an embodiment of the control system of the invention the delayed torque intervention signal comprises: a delayed first actuator torque intervention request; or a delayed second actuator torque intervention request. The control system modulates the raw torque intervention to delay either the request of a first actuator torque intervention or a second actuator torque intervention. The delay in the torque intervention request enables fine tuning of the actuators in use so that for example, both actuators have sufficient time to reach a state whereby they are able to provide the torque intervention. The control system applies a timing delay to either the torque intervention signal controlling a first actuator torque intervention or a timing delay to the torque intervention signal controlling a second actuator torque intervention. The result is that the torque intervention of either of the two components is delayed. By applying a timing delay to one of the torque intervention signal the machine can better synchronise the control of the first and second actuator torque intervention resulting in finer control of the vehicle and the gearshift itself.

In an embodiment of the control system of the invention, the one or more input parameters comprises one or more delay parameters, and the control system determines the length of the timing delay to apply to the torque intervention signal in dependence upon the one or more delay parameters. The length of the timing delay can Optionally be adapted using one or more delay parameters. The delay parameters are utilised by the control system to calculate the required delay time needed to enable the first and second actuators to provide a torque intervention at the same time, or substantially the same time. For example, in different driving scenarios the required delay time may be shorter or longer in dependence on one or more parameters such as if the engine is in a fuelled or unfuelled state.

In an embodiment of the control system of the invention, the one or more delay parameters comprises one or both of: engine fuelling state data and engine speed data. The length of time required for the timing delay depends upon the current fuelling state of the engine. Where an engine is in a fuel cut state or low fuel state time is needed to bring the engine back to a fuelled state, in such a scenario a decrease in the timing delay means the engine begins firing up much quicker. Alternatively, where the engine is already in a fuelled state the timing delay is longer as the engine does not need to be fuelled. The fuelling state data optionally allows finer control of the timing delay for different driving scenarios.

The use of engine speed data to determine the length of the delay is advantageous as the control system takes into account the present engine speed and can therefore determine whether there needs to be an increase in engine speed or decrease in engine speed. The timing delay can thus be adjusted taking into account the engine speed.

In an embodiment of the control system of the invention, the one or more delay parameters comprises one or both of: data relating to an intervention type determined by the control system in accordance with the gear change signal. By taking into account the intervention type, the control system can optionally tailor the length of the timing delay to an upshift or a downshift. An upshift as compared to a downshift has different requirements on one or both actuators as such a different timing length may be required depending on the intervention type in question and magnitude thereof. Likewise, a downshift as compared to an upshift has different requirements on one or both actuators as such a different timing length may be required depending on the intervention type in question and magnitude thereof.

In an embodiment of the control system of the invention, the one or more delay parameters comprises one or more of: real time-data and stored data. The real time data of utilised by the control system optionally allows the control system to take into account any current vehicle parameters, such as engine speed and/or fuelling state, when the vehicle is driving, into the determination of the timing delay (which actuator, how long). The real-time data can be provided, for example, by one or more inputs, sensors or monitoring devices which are configured to connect to the control system. The use of real-time data enables greater adaptability of the control system in use.

Also, or alternatively, by pre-determining delay parameters during a calibration step during at least one of: a design, testing, calibration, system update and/or manufacturing step, the control system can run more efficiently and quickly as it does not need to re-calculate on the fly required timing delays, but could, for example, read them from a memory in the form of a look-up table or the like. For example, network and signalling delays can be determined during development, as well as actuator response times under certain conditions.

In an embodiment of the control system of the invention, the control system is arranged to determine, for each of the two actuators, a total path delay in dependence upon one or more of the one or more delay parameters, the total path delay representing a time period from the control system outputting a torque intervention request for that actuator to deliver torque to an actual delivery of the requested torque; and wherein the timing delay is applied to the torque intervention signal for the actuator with the shorter total path delay to cause the torque intervention from the two actuators to occur at substantially the same time.

The control system determines the total time of the delay for each actuator path, for example by summing a number of delays in a path of each actuator in dependence on the delay parameters. The determination may include, for example, both network delay and physical delay of an actuator among other delay parameters which are representative of the time period between a request and actual delivery of the torque intervention. The timing delay is then applied to the torque intervention signal of the actuator with the shorter total path delay, so that the combined torque intervention of both actuators occurs at substantially the same time. The timing delay to be applied may be the difference between the total path delay for each of the two actuators.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to: delay outputting of the torque intervention signal to improve alignment of the combined torque intervention from the two actuators.

According to an aspect of the present invention there is provided a system. The system comprising the control system of any embodiment of the control system aspect and a first actuator and a second actuator. Providing a system with two actuators and the control system provides the advantageous discussed above.

According to an aspect of the present invention there is provided a vehicle. The vehicle comprises the control system of the control system aspect or the system of the system aspect. The provision if the control system or system on a vehicle optionally provides the advantages described above. The vehicle may be a hybrid electric vehicle. The hybrid electric vehicle may be a Plug-in Hybrid Electric Vehicles (PHEV) and/or a Mild Hybrid Electric Vehicles (MHEV).

According to an aspect of the present invention there is provided a method for controlling a combined torque intervention of two actuators to a transmission system of a vehicle. The method comprising: receiving a gear change signal that is indicative of a requirement to perform a gearshift; receiving one or more input parameters; in dependence on the one or more input parameters, determine a timing delay for a torque intervention signal that requests part of the combined torque intervention from a first one of the two actuators; and in dependence on the determined timing delay, delay outputting the torque intervention signal to improve alignment of the combined torque intervention from the two actuators.

The method provides the advantages of the preceding aspects. The method may comprise the further restrictions of any of the preceding aspects. For example, the method may further comprise the control system and/or any of the embodiments thereof. Likewise, the method may comprise the system and/or vehicle.

There is also provided a method for controlling a combined torque intervention of two actuators to a transmission system of a vehicle. The method comprising: receiving one or more input parameters; in dependence on the one or more input parameters, determine a timing delay for a torque intervention signal that requests part of the combined torque intervention from a first one of the two actuators; and in dependence on the determined timing delay, delay outputting the torque intervention signal to improve alignment of the combined torque intervention from the two actuators.

The same advantages of this additional method are also present as described above in relation to the other method. Similarly, the method provides the advantages of the preceding aspects. The method may comprise the further restrictions of any of the preceding aspects. For example, the method may further comprise the control system and/or any of the embodiments thereof. Likewise, the method may comprise the system and/or vehicle.

According to an aspect of the present invention there is provided computer readable instructions which, when executed by a computer, are arranged to perform a method according to the previous aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an example of a vehicle in accordance with an embodiment of the invention;

FIG. 2 shows a control system in accordance with an embodiment of the invention;

FIG. 3 shows a schematic example of at least part of a powertrain of the vehicle of FIG. 1;

FIG. 4 shows a flow chart of logic for determining and applying the timing delay in accordance with an embodiment of the invention;

FIG. 5 shows a flow chart of logic for determining and applying the timing delay in accordance with an embodiment of the invention;

FIG. 6 shows a flow chart of logic for determining and applying the timing delay in accordance with an embodiment of the invention;

FIG. 7 shows a flow chart of logic for determining and applying the timing delay in accordance with an embodiment of the invention.

FIG. 8 shows a graphical representation of a gear change without a combined intervention;

FIG. 9 shows a graphical representation of a combined intervention in accordance with an embodiment of the invention;

FIG. 10 shows a graphical representation of a combined intervention during an initial engine unfuelled state in accordance with an embodiment of the invention;

FIG. 11 shows a graphical representation of a combined intervention during an initial engine fuelled state in accordance with an embodiment of the invention;

FIG. 12 shows a graphical representation of a combined intervention during multiple torque interventions in accordance with an embodiment of the invention; and

FIG. 13 shows an alternative graphical representation of a combined intervention during multiple torque interventions in accordance with an embodiment of the invention.

### DETAILED DESCRIPTION

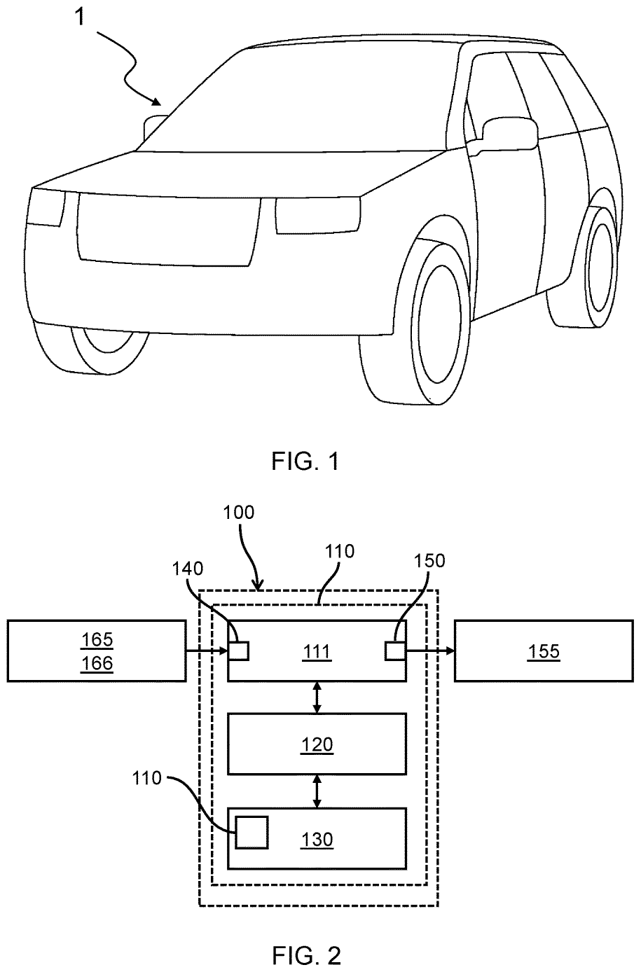

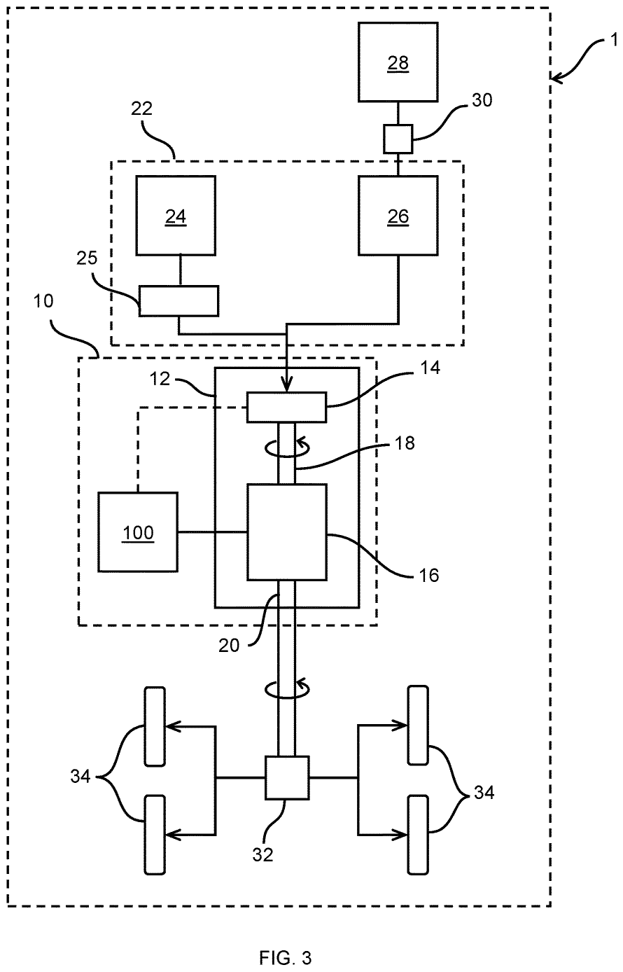

A control system 100 in accordance with an embodiment of the present invention is described herein with reference to the accompanying FIGS. 1 to 13. The control system 100 is suitable for controlling a combined torque intervention of two actuators 24, 26 of a transmission system of a vehicle 1. As shown in FIG. 3, the control system 100 is installed in a vehicle 1.

The vehicle 1 in accordance with an embodiment of the present invention is described herein with reference to the accompanying FIG. 1. In some, but not necessarily all examples, the vehicle 1 is a passenger vehicle, also referred to as a passenger car or as an automobile. In other examples, embodiments of the invention can be implemented for other applications, such as commercial vehicles.

FIG. 3 schematically illustrates an example of at least part of a powertrain of the vehicle 1.

In this example, the vehicle 1 comprises a propulsion system 22 comprising a plurality of torque sources 24, 26 (also referred to generically as: actuators 24, 26 or power sources 24, 26) which are selectively operable for the purpose of providing drive torque for accelerating the vehicle 1. A torque source refers to a prime mover, such as an internal combustion engine, an electric machine such as a traction motor, or the like.

In the illustrated example, the propulsion system 22 comprises two torque sources 24, 26. A first torque source 24 is an internal combustion engine (‘engine’). A second torque source 26 is an electric machine.

The electric machine 26 is an electric motor arranged to convert electrical energy into kinetic energy in the form of mechanical torque and is also arranged to convert kinetic energy in the form of kinetic energy into electrical energy. The electric motor 26 may be an alternating current induction motor or a permanent magnet motor, or another type of motor. The electric machine 26 is a traction motor configured to enable at least an electric mode comprising electric-only driving. That is, the electric machine 26 can drive the vehicle 1 by itself (without an engine). Another term for the electric machine 26 is an electric drive unit (EDU).

This propulsion system 22 is configured to operate in a plurality of predefined operating modes. These include at least an electric mode and a parallel hybrid mode.

In the electric mode (also known as electric vehicle (EV) mode or electric-only mode) the vehicle 1 is propelled only by torque generated by the electric machine 26, with the engine clutch 25 handling whether the engine is connected to the drivetrain and part of the torque path to the wheels 34.

In the parallel hybrid mode the vehicle 1 is propelled by torque generated by both the engine 24 and by the electric machine 26.

Transitioning between predefined operating modes of the propulsion system 22 comprises turning on or off one of the torque sources 24, 26 so that, respectively, it either does or does not output torque. In some examples, transitioning between predefined operating modes may further comprise mechanically connecting (coupling) or disconnecting (uncoupling) one of the torque source 24, 26 to the drivetrain. It will be appreciated that the transition between the predefined operating modes is not instantaneous. While the propulsion system 22 is transitioning between predefined operating modes, its mode status is ‘in transition’.

The vehicle 1 comprises an automatic transmission system 10 comprising an automatic transmission 12 and the control system 100 such as a transmission control unit/module for controlling the automatic transmission 12.

The automatic transmission 12 comprises an input clutch 14 (also generically known as a coupling element 14) which transfers torque output by the operating torque sources 24, 26 of the propulsion system 22 to the transmission input shaft 18. The input clutch 14 may be a wet clutch such as a torque converter or one or more automatically-actuated friction clutches as found in, for example, a dual-clutch transmission.

The automatic transmission 12 also comprises a gear set and accompanying shifting mechanism, referenced in combination as 16. The gear set comprises a plurality of gears which are selectively couplable into different gear trains to enable multiple gear ratios between the transmission input shaft 18 and the transmission output shaft 20.

The clutches and their actuators form the shifting mechanism.

The shifting mechanism is controlled to establish a selected gear ratio in accordance with a control signal output by the control system 100, alternatively this may be achieved by a second control system within the vehicle connected or connectable to and in communication to the first control system 100 of the present invention.

The control system 100 is also capable of controlling actuation of the input clutch 14.

The transmission output shaft 20 is connected to a final set of gears 32, such as a pinion gear meshed with a ring gear, to transfer torque to the wheel axles and thus the vehicle wheels 34.

In order to store electrical energy for the electric machine 26, the vehicle 1 comprises an electrical energy storage means 28. The electrical energy storage means 28 can be a traction battery. The traction battery 28 provides a nominal voltage required by electrical power users such as the electric machine 26.

The traction battery 28 may be a high voltage battery. The traction battery 28 may have a voltage and capacity to support electric only driving for sustained distances. The traction battery 28 may have a capacity of several kilowatt-hours, to maximise range. The capacity may be in the tens of kilowatt-hours, or even over a hundred kilowatt-hours.

Although the traction battery 28 is illustrated as one entity, the function of the traction battery 28 could be implemented using a plurality of small traction batteries in different locations on the vehicle 1.

An inverter 30 converts between the DC output of the traction battery 28 and the AC input required for the electric machine 26.

In view of the above description of the vehicle 1, it will be understood that the vehicle 1 is a full hybrid electric vehicle (HEV). However, in some examples the vehicle 1 may be other than as shown in FIG. 3. The vehicle 1 may be a battery electric vehicle (BEV), a plug-in electric hybrid vehicle (PHEV), a mild hybrid electric vehicle (MHEV), an internal combustion engine vehicle (ICEV) or otherwise.

MHEVs do not have an electric-only mode of propulsion, but the electric machine 26 may be configured to provide assistance such as boosting output torque of the engine 24. The electric machine 26 is not sufficiently powerful to drive the vehicle 1 under electric power alone.

BEVs are an electric-only vehicles which are propelled by an electric machine 26 which receives power from an on-board traction battery 28.

ICEV are propelled solely by an engine 24. Any on-board electric machine is used only as a starter-generator.

With reference to FIGS. 2 and 3, the control system 100 will be described in more detail. The control system 100 comprises one or more processors 110.

The one or more processors 110 are collectively configured to receive a gear change signal 165 that is indicative of a requirement to perform a gearshift. The control system 100 is also configured to receive one or more input parameters 166. The control system 100 in dependence upon the one or more input parameters, determines a timing delay suitable for a torque intervention signal that requests part of the combined torque intervention from a first of the two actuators 24, 26. The control system 100, in dependence on the timing delay, delays outputting of the torque intervention signal to improve alignment of the combined torque intervention from the two actuators 24, 26. The control system may then output a control signal 155 to one of the two actuators 24, 26 causing the each one of the two actuators 24, 26 to each provide a torque intervention at substantially the same time.

The control system 100 as illustrated in FIG. 2 comprises one processor 110, although it will be appreciated that this is merely illustrative and that more than one processor 110 may be provided. The processor 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The processor 110 comprises an input means 140 and an output means 150. The input means 140 may comprise an electrical input 140 of the processor 110. The output means 150 may comprise an electrical output 340 of the processor 110. The processor 110 may have an interface comprising 111 the input means 140 and output means 150. The input means 140 is arranged to receive a gear change signal 165 from a sensor. The gear change signal 165 is an electrical signal which is indicative of a requirement to perform a gearshift. The input means 140 is also arranged to receive one or more input parameters 166. The output 150 is arranged to output a control signal 155 being a delayed output of a torque intervention signal that is suitable for controlling combined torque intervention. The control signal 155 improves alignment of the combined torque intervention from the two actuators 24, 26.

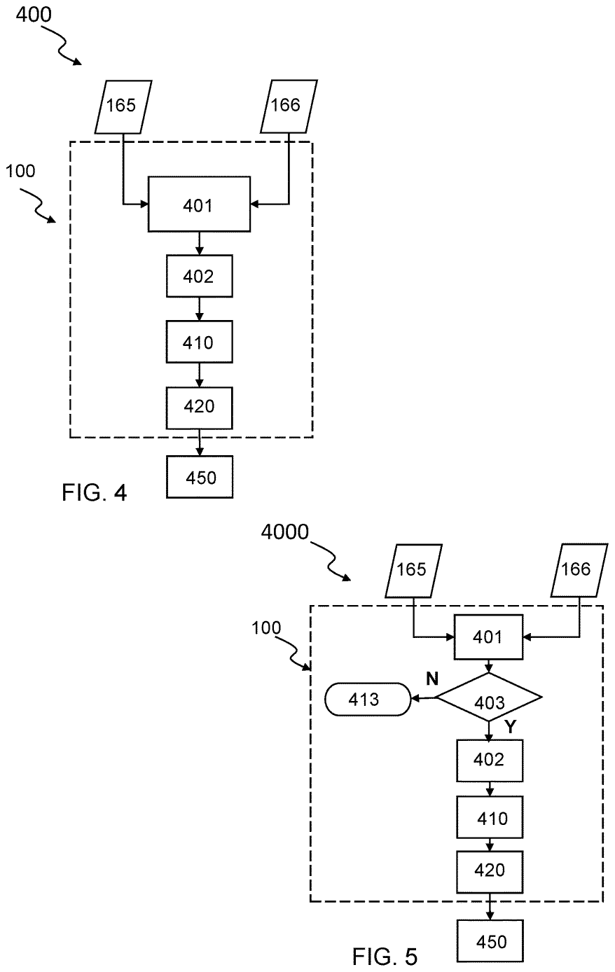

The control system 100 and steps undertaken by the one or more processors 110 to output a delayed torque intervention signal 303, 305 will be discussed in more detail with the aid of FIGS. 4, 5, 6 and 7. FIG. 4 shows a schematic flow chart 400 of the determination of the timing delay td which takes place in the control system 100. In this flow chart steps which takes place within the control system 100 are represented by being located within the dashed line which represents the control system 100.

The control system 100 receives inputs 165, 166. The input 165 is the gear change signal 165, this is an electrical signal which is indicative of a requirement to perform a gearshift. The input 166 comprise the one or more input parameters 166.

After receiving the inputs 165, 166 at a step 401 the control system 100 at step 402 determines a timing delay td to delay outputting of a torque intervention signal 302 which corresponds to actuator 24. The timing delay td may be a constant value applied to the torque intervention signal request 302 or alternatively a calculated variable or one obtained from a look-up table. The timing delay td may be the sum of all the physical and network delays for the actuator 26 minus the sum of all the physical and network delays for the actuator 24. Or, the timing delay td may be the sum of all the physical and network delays for the actuator 24 minus the sum of all the physical and network delays for the actuator 26.

At step 410 a timing delay td is used to delay the outputting of the actuator torque signal request 302 of an actuator 24. The delayed actuator torque intervention signal 302 becomes the delayed torque intervention signal 303 due to the timing delay td. Then, at step 420, the control system 100 outputs the delayed torque intervention signal 303. The result is that at step 450 the actuator 24 provides its part of the combined torque intervention in a delayed fashion as compared to an un-delayed torque intervention signal.

Whilst the example described is discussed in reference to the first actuator 24 it will be apparent that the operation can be used with the second actuator 26 to delay the actuator torque signal request 304 without additional steps or departing from the scope of the invention.

The one or more inputs 166 may include a first actuator torque intervention request 302 dependent at least upon a gear change signal 300 and/or a second actuator torque intervention request 304 dependent at least upon the gear change signal. The magnitude and direction of the torque intervention (upshift or downshift) required can alter the length of timing delay to apply. For example, an increase in engine speed for actuator 24 required for a desired torque intervention, as compared to a decrease in engine speed, may require a longer timing delay to be applied to the actuator 26, as actuator 24 may require longer to reach the required speed. Therefore, taking into account the first and second actuator torque intervention requests 302, 304 a combined torque intervention at sufficiently the same time is provided.

The one or more inputs parameters 166 may include a combined intervention request signal. The combined intervention request signal is a flag which indicates that a combined intervention is to take place. Where the flag is active, then the control system 100 undertakes the steps to delay timing of one of the actuator torque signal requests 302, 304. Where a combined intervention request signal is inactive then a combined intervention is not required and a gear change may proceed utilising only one of the two actuators 24, 26.

The one or more input parameters 166 may comprise delay parameters. The delay parameters are used to determine the length of the timing delay td to apply. The delay parameters can be dependent upon real time-data obtained from, for example, sensors configured to detect variables in the first actuator 24 or second actuator 26 such as engine speed.

These delay parameters can comprise an engine speed data. This data can be gathered by one or more sensors disposed in the vehicle at appropriate points. Where the engine is at a certain speed it takes a certain length of time to react and provide the requested propulsion torque. This time is quantified or determined or calculated by the control system 100 or stored in a look-up table which the control system 100 can access. For example, the look-up table can comprise data stating that the time to change from a first engine speed to a second engine speed takes 0.1 seconds indicating that a required delay to use is thus 0.1 seconds for this operation. This delay may be summed with other timing delays, such as network delays or other physical delays.

These delay parameters can comprise an engine fuelling state data. The timing delay td is dependent upon the engine fuelling state. If the engine 24 is currently unfuelled and the cylinders are not firing then it will take a length of time to bring the engine 24 into an engine fuelled state from the engine unfuelled state before the engine 24 can provide its portion of the combined torque intervention. As such, the timing delay will be longer when the engine 24 is in an unfuelled state, timing delay tu as compared to the fuelled state, timing delay tf, in order to compensate for bringing the engine 24 into a fuelled state.

The delay parameters can further comprise information relating to an intervention type determined by the control system in accordance with the gear change signal 165. The magnitude of the gear change requested can require different lengths of times. For example, a shift from 3^{rd} to 5^{th} gear requires a greater torque pulse than a 3^{rd} to 4^{th} gear. Where the magnitude is greater there is the potential that the actuator 24, 26 may require longer to meet the required torque, therefore the timing delay td used is longer to compensate. Likewise, the direction of the shift may impact the timing delay, an upshift compared to a downshift has different requirements of torque and speed. The result is that the timing delay td of an upshift compared to a downshift can be different. Alternatively, the timing delay td for an upshift and downshift can be the same.

Alternatively, or also, the delay parameters may be stored data stored in the memory means 130. The control system 100 can access the memory means 130 to access appropriate information for determining the timing delay td, such as from a look-up table. The timing delays td identifiable from the look-up table can be obtained by comparing real time data with points in the look-up table to identify the most appropriate timing delay for the current driving conditions. For example, the look-up table may comprise data relating to engine speed, torque demand, intervention type, engine fuel state.

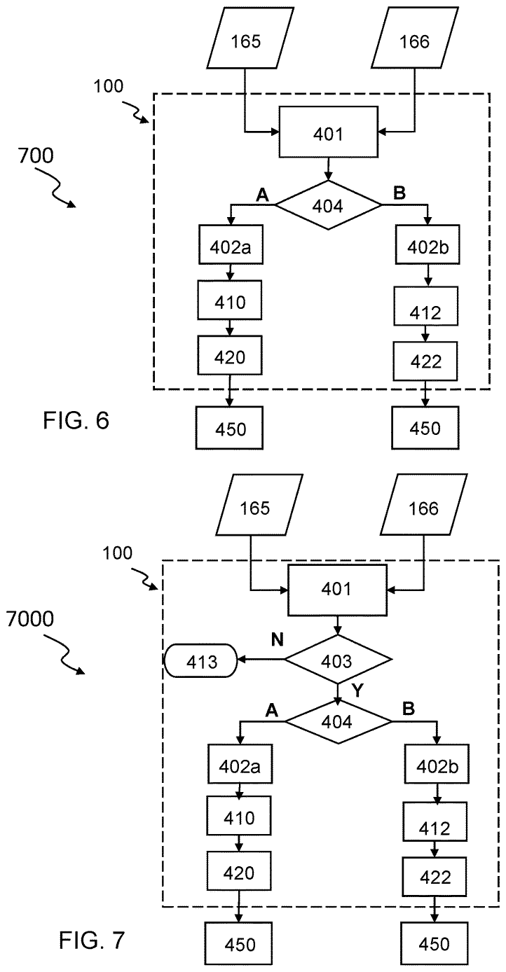

In FIG. 6 an alternative flow chart 700 with additional control system logic is described. A number of the steps of flow chart 700 are the same as flow chart 400, additional steps are described below.

After step 401 a decision step 404 is provided. At step 404 the control system 100 determines to which of the first actuator 24 or second actuator 26 to provide the delayed torque intervention signal 303, 305. The determination of the timing delay td for actuator 24 at a step 402a or the determination of a timing delay td for actuator 26 at a step 402b is made on each branch stemming from decision step 404. Step 402a, 402b may be the same as step 402 described above.

At step 404 the one or more processors 110 are optionally configured to determine whether to utilise the timing delay td for the first actuator 24 or the second actuator 26.

Depending on the selection (indicated as “A” or “B” on a branch of decision box at step 404 in FIG. 6) then one or more processors 110 choose to delay outputting the torque intervention signal of the first actuator 24 or second actuator 26 at step 404. The one or more processors 110 then proceed to either step 402a to determine the timing delay td onto actuator 24 (branch “A”) and subsequently on to step 410, or step 402b (branch “B”) to determine the timing delay td onto actuator 26, and then on to a step 412.

As shown by comparison with FIG. 9, at step 410 the timing delay td is used to delay the outputting of the actuator torque signal request 302 of an actuator 24. The delayed actuator torque intervention signal 302 becomes the delayed torque intervention signal 303 due to the timing delay td. Then, at step 420, the control system 100 outputs the delayed torque intervention signal 303. The result is that at step 450 the actuator 24 provides its part of the combined torque intervention in a delayed fashion as compared to an un-delayed torque intervention signal.

Optionally, at step 404 the one or more processors 110 are optionally configured to determine to apply the timing delay td to the first actuator 24 or the second actuator 26. In this option, the choice of actuator 24, 26 to apply the timing delay td to, is undertaken by decision logic carried out by the one or more processors 110 by determining a total path delay td1, td2 of each of the first and second actuators 24, 26. The control system 100 determines the total path delay td1, td2 using the one or more processors 110.

The total path delay td1 represents the total timing delay taking of the first actuator 24. The total path delay td1 takes into account the sum of the physical and network delays from the time control system 100 outputs the torque intervention signal 302 at time to to the actual torque being supplied at time t1. Total path delay td1 may be pre-determined during a design, testing calibration, system update or manufacturing step and saved in the memory means 130 accessible to the one or more processors 110. Optionally, the one or more processors 110 could calculate this value using real-time data determined from one or more sensors or monitoring devices which are configured to connect to the control system. Optionally, the one or more processors 110 could calculate the value based on both the pre-determined data and the real-time data.

The total path delay td2 represents the total timing delay taking of the second actuator 26. The total path delay td2 takes into account the sum of the physical and network delays from the time control system 100 outputs the torque intervention signal 304 at time t0 to the actual torque being supplied at time t2. Total path delay td2 may be pre-determined during a design, testing calibration, system update or manufacturing step and saved in the memory means 130 accessible to the one or more processors 110. Optionally, the one or more processors 110 could calculate this value using real-time data determined from one or more sensors or monitoring devices which are configured to connect to the control system. Optionally, the one or more processors 110 could calculate the value based on both the pre-determined data and the real-time data.

The one or more processors 110 of compare the two calculated total path delays td1 and td2.

If td1 is greater than td2 then a timing delay td is applied to the actuator torque signal request 304 for controlling the actuator 26. As such, the one or more processors 110 move from step 404 to step 402b and then step 412 (indicated as “B” on a branch of decision box at step 404 in FIG. 6). In such a scenario, the timing delay td identified at step 402b may be the absolute value of the difference between td1 and td2. Then subsequently, at step 422 the control system 100 outputs the torque intervention signal 304 and a delayed torque intervention signal 305. Optionally the timing delay td utilised may be one identified using one of the other methods described above.

Alternatively, and as shown on FIG. 9, if td2 is greater than td1 then a timing delay td is applied to the actuator torque signal request 302 for controlling the actuator 24. As such, the one or more processors 110 move from step 404 to step 402a and then step 410 (indicated as “A” on a branch of decision box at step 404 in FIG. 6). In such a scenario, the timing delay td identified at step 402a may be the absolute value of the difference between td1 and td2. Then subsequently, at step 420 the control system 100 outputs the torque intervention signals 302 and a delayed torque intervention signal 303. Optionally the timing delay td utilised may be one identified using one of the other methods described above.

In other words, the timing delay td is applied to the torque intervention signal 302, 304 for the actuator 24, 26 that has the shorter total path delay td1, td2 respectively.

Optionally, for either flow chart 400 or 700, where the input parameters 166 comprise a combined intervention request signal, the flowcharts may have an additional step 403. Flow chart 4000 is shown in FIG. 5. FIGS. 4 and 5 share a number of common features with the addition of step 403 in FIG. 5. Flow chart 7000 is shown in FIG. 7. FIGS. 6 and 7 share a number of common features with the addition of step 403 in FIG. 7.

Step 403 is located after step 401 but before step for 402 (for flow chart 4000) or before step 404 (for flow chart 7000). Step 403 has two branching paths (indicated as “Y” or “N” on a branch of decision box at step 404 in FIG. 6). The “Y” branch proceeds to step 402 or 404 as applicable. The “N” path causes the logic to move to a step 413.

Where a combined intervention request signal is inactive then a combined intervention is not required and a gear change may proceed utilising only one of the two actuators 24, 26. As such, at step 403 if the combined intervention request signal is inactive, the one or more processors 110 stop the control system logic (step 413) and the one or more processors 110 do not proceed to step 402 or 404 as applicable. If, on the other hand, the combined intervention request signal is active, then the one or more processors 110 proceed from step 403 to step 402 or 404 as applicable and the control system logic continues. In such a way, the one or more processors 110 may be configured to consider the combined intervention request signal prior to undertaking any further steps.

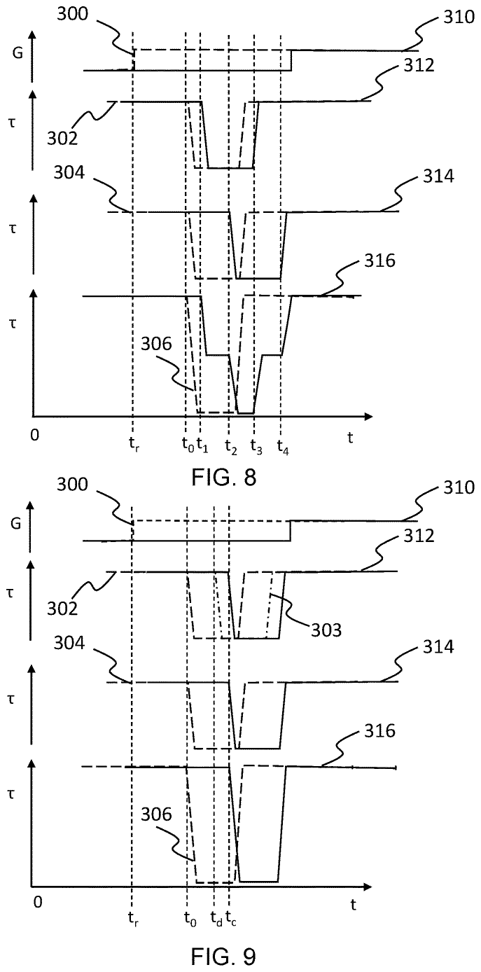

With the aid of FIGS. 8 to 13, the combined torque intervention will be described.

FIG. 8 illustrates the request and torque intervention of first actuator 24 and a second actuator 26 during a gearshift in a simplified form without a combined torque intervention. On the X-axis is time, t in seconds. The Y-axis shows torque, τ in Nm. Also shown on the Y-axis is a value of gear G.

The graph shows a gear shift request 300, actuator torque signal requests 302, 304 and torque request 306 are shown in dotted lines. The actuator torque signal requests 302, 304 are the requested torque to be supplied from each actuator 24, 26. One actuator 24, 26 could supply more torque than the other or both could supply the same quantity of torque. The combined torque request 306 is the combination (sum) of both actuator torque signal requests 302, 304 and indicates the total torque required for an intervention.

The actual gear 310 (i.e. current gear at a point in time), actual actuator torque supplied 312, 314 and combined torque delivery 316 are shown in solid lines. The actual actuator torque supplied 312, 314 is the torque physically supplied by each actuator in practice. The combined torque delivery 316 is the combination (sum) of both actuator torque supplied 312, 314 curves.

For clarity, the dashed lines and solid lines partially overlap. For reasons of clarity and ease of comparison the curves are shown separately, in practice the torque-time curves may at least partially overlap. All the curves share a common X-axis.

The gearshift request 300 occurs at a time tᵣ. In the example of FIG. 8 this is an upshift with the gear going to a higher gear from an initial lower gear. After tr at t0 a control system 100 requests both a first actuator 24 (of the two actuators 24, 26) to perform a torque intervention (actuator torque signal request 302) and a second actuator 26 to perform a torque intervention (actuator torque signal request 304). The torque request “pulses” for both the actuators 24, 26 indicated by actuator torque signal requests 302, 304 are shown to be substantially the same length of time.

The combined requested torque of both the actuators 24, 26 is indicated by the torque request 306 line. In this example each request 302, 304 is sent to each actuator at time to without a timing delay td. In practice the request may reach each actuator at different times due to network delays or other system delays. As such each actuator 24, 26 will process the request 302, 304 at different times, this compounded with physical delays for the actuators 24, 26 preparing to deliver the torque requested causes the torque delivery of the two actuators 24, 26 to be out of sync such that the physically supplied torque is delivered at different times as shown in FIG. 9 line 316.

The first actuator 24, at time t1, begins to provide a torque intervention as indicated by actual actuator torque supplied 312 line. The change in torque is indicated by the combined torque delivery 316 line. It is clear from comparing the torque request 306 and combined torque delivery 316 lines between t1 and t2 that the full torque requested is not provided by the actuation of the first actuator 24 alone. The curve of line 312 follows line 302 with a delay time td1 of the difference between t1-t0. The delay time td1 may be due to physical delays in the actuator 24 or other network delays.

At time t2 (after t1) the second actuator then provides torque as indicated by actual actuator torque supply line 314. At this point the torque requested by torque request 306 is achieved in practice as shown by the combined torque delivery 316 curve. The curve of line 314 follows line 304 with a delay time td2 of the difference of t2-t0. The delay time td2 may be due to physical delays in the actuator 24 or other network delays.

As will be apparent, in FIG. 8, the delay time td2 is greater than delay time td1. As such, the actuator 26 will provide a torque intervention at a time after the other actuator 24. The result is the stepped combined torque delivery 316 curve which does not follow the torque request 306 curve, and more particularly the shape of the requested torque intervention 306 curve.

At time t3 (after t2) the first actuator 24 then removes the supplied torque as indicated by actual actuator torque supplied line 312. This follows the trace of the torque request 302.

Subsequently at t4 (after t3) the second actuator 26 then removes the supplied torque as indicated by actual actuator torque supplied line 314. This follows the trace of the torque request 304.

As each of the actuators 24, 26 finish their torque interventions at different times, the combined torque delivery 316 curve is again stepped as shown in FIG. 8.

The stepped combined torque delivery 316 means that a less smooth torque delivery is achieved in practice as the actuators are not synchronised in their delivery of torque at the input shaft 18 side of the transmission of vehicle 1. This can result in a noticeable and undesirable decrease in shift feel performance or character when a torque intervention occurs in practice.

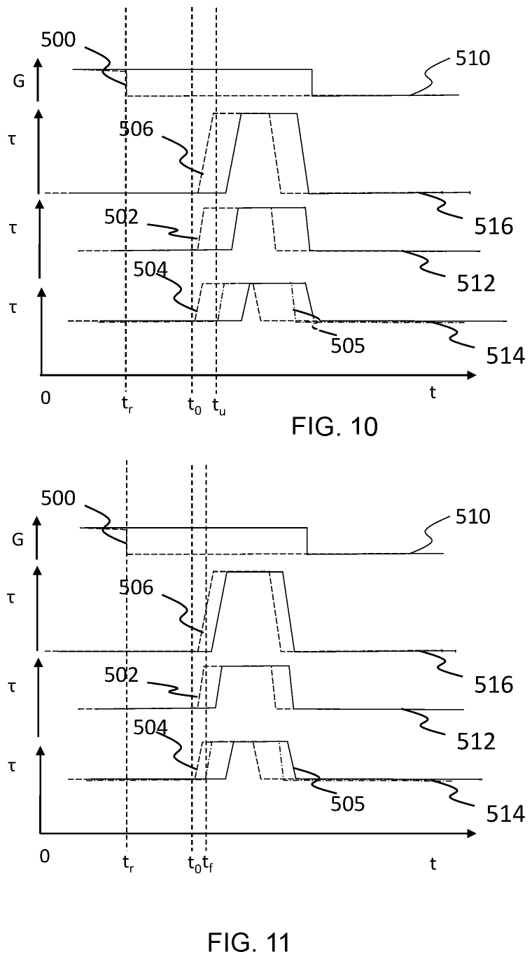

Whilst FIG. 8 shows an upshift (and thus a decrease in requested torque) the same principle holds for a downshift in gear where an increased torque would be requested by a control system (an example of a downshift according to the invention is shown graphically in FIG. 10).

The combined torque intervention of the present invention solves this problem. This will be explained with reference to FIGS. 8 and 9. FIG. 9 shows a combined torque intervention using two actuators 24, 26 where torque delivery at the input shaft 18 side of the transmission of the vehicle 1 is achieved at substantially the same time. FIGS. 8 and 9 share a number of common features, as such substantially the same numbering will be employed for ease of comparison. For ease of comparison with FIG. 8, FIG. 9 also shows an upshift.

In FIG. 9 a gear shift request 300 is made at time tr and torque intervention request at t0. Subsequently, the control system 100 undertakes the steps of flow chart 400, 700 to determine a timing delay td to apply. The determination of the timing delay td by the control system 100 and assigning this to a particular actuator torque signal request 302, 304 is discussed in more detail above.

The control system 100 delays outputting of one of the two actuator torque signal requests 302, 304. In the example of FIG. 9 the delayed actuator torque signal request 302, 304 is the request 302. This delayed request 302 becomes an actuator delayed torque intervention signal 303 (shown in a dot-dashed line in FIG. 9).

The delayed torque intervention signal 303 delays the actuator torque signal request 302 by a time td compared to to where the second actuator torque signal 304 is output. The length of time td is discussed in more detail above with reference to the determination of the timing delay td by the control system 100. By delaying the request 302 as a delayed torque intervention signal 303 the control system 100 improves alignment of the combined torque intervention from the two actuators 24, 26. The actual torque supplied 312, 314 from each of the actuators 24, 26 occurs at substantially the same time as indicated by the actual actuator torque supplied 312 curve at time to that indicates the start of the combined torque intervention. In comparison to FIG. 8 the actual actuator torque supplied 312 curve is not stepped between t1 and t3. The result of the synchronised combined torque intervention of the invention in FIG. 9, compared to a non-synchronised combined intervention as in FIG. 8 is a smoother gear change as all the required torque is supplied at the input shaft 18 side of the transmission at substantially the same time.

Actuation at substantially the same time in the case of the present invention means within the range of 0 to 0.1 seconds, or 0.001 to 0.1 seconds, or 0.01 to 0.1 seconds.

It will be appreciated that the timing delay can be used to delay actuation of either the first actuator 24 or second actuator 26, or both. Similarly, it will be appreciated that the timing delay can be applied during an upshift as shown in FIG. 9 or in a downshift as shown in FIGS. 10 and 11.

An example of a downshift is shown graphically in FIGS. 10 and 11. FIG. 10 shows a graph where the first actuator 24 is an engine 24 and is initially in the engine unfuelled state.

Each of graphs in FIGS. 10 and 11 show a gear shift request 500, in this instance a downshift. FIGS. 10 and 11 share a number of common features with FIGS. 8 and 9, as such substantially the same numbering will be employed for ease of comparison whilst being prefixed by “500”.

In order to provide a combined intervention, the second actuator 26, in this instance an electric machine 26, the actuator torque signal request 504 is delayed by time tu to become delayed torque intervention signal 505 (shown in the dot-dashed line in FIG. 10). The delayed torque intervention signal 505 delays the second actuator providing its part of the combined torque intervention so that it can be provided substantially at the same time as the first actuator's 24 part of the combined torque intervention.

FIG. 11 by comparison shows a graph where the first actuator 24 is an engine 24 that is initially in the engine fuelled state. In this instance the timing delay tf is shorter in length as compared to the timing delay tu shown in FIG. 10.

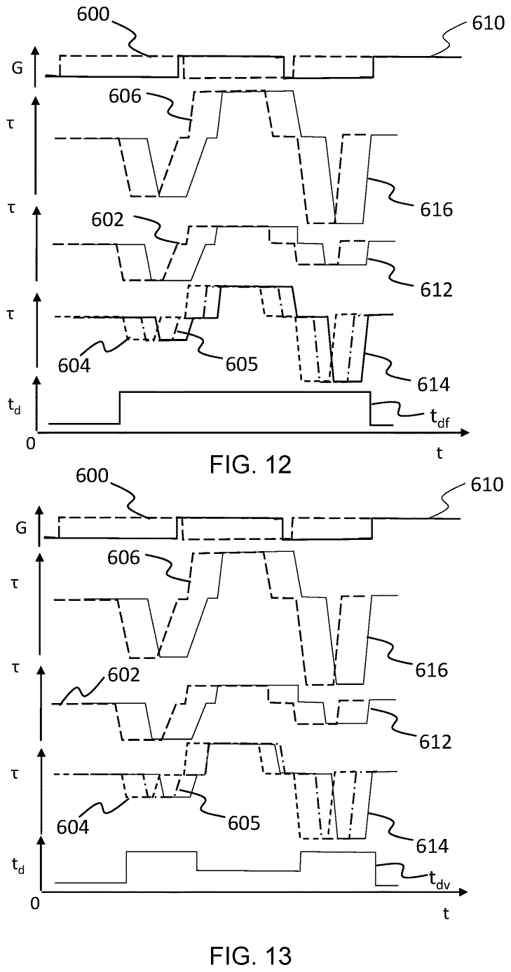

The combined intervention timing delays td are also able to be used in quick succession by a vehicle 1. This will be explained with the aid of FIGS. 12 and 13 which show a combined torque intervention during a fast upshift-downshift-upshift gear change. FIGS. 12 and 13 share a number of common features with FIGS. 8 and 9, as such substantially the same numbering will be employed for ease of comparison whilst being prefixed by “600”.

In FIG. 12 the timing delay td is shown graphically for each of the combined interventions. In FIG. 12 the timing delay td is a constant value tdf and does not vary with the type of intervention requested by gear shift request 600. Td is provided on the Y-axis with the curve of the timing delay tdf sharing a common X-axis with the other curves shown in FIG. 12. As can be seen from the delayed torque intervention signal 605 shown in a dot-dashed line in FIG. 12 the timing delay tdf is constant through each of the three separate interventions in accordance with the steps described in flow chart 400 or 700, as long as the delayed intervention request is not complete before the next raw request starts.

In FIG. 13 an alternative configuration is shown where the timing delay td is variable for each combined intervention, timing delay tdv. As shown in FIG. 13 the timing delay tdv varies and is different for the upshifts and the downshift 600, 610. The one or more processors 110 of the control system 100 determines a timing delay for the first or second actuator. In the event described on FIG. 13, the second actuator 26 torque intervention request for each of the interventions is delayed with the individuals delays reflected on timer tdv, in accordance with the steps described in flow chart 400 or 700.

Whilst both FIGS. 12 and 13 show an upshift-downshift-upshift type intervention it will be appreciated that the combined torque intervention utilising a fixed timing delay tdf or a variable timing delay tdv can be applied to a downshift-upshift-downshift type intervention. Likewise, the invention is similarly applicable to multiple upshifts in quick succession or multiple downshifts in quick succession or any combination of shifts and related interventions. Further, the invention is similarly applicable to any combination of quick upshifts and downshifts within a period of time.

The control system 100 allows the configuration of either a single, or different individual delays, as highlighted with specific use cases in FIGS. 12 and 13.

It will be appreciated that various changes and modifications can be made to the present invention without departing from the scope of the present application.

1. A control system for controlling a combined torque intervention of two actuators to a transmission system of a vehicle, the control system comprising one or more processors, the one or more processors collectively configured to:
receive a gear change signal that is indicative of a requirement to perform a gearshift and output a torque intervention signal that requests part of the combined torque intervention from a first one of the two actuators in response to the received gear change signal, wherein the one or more processors are further collectively configured to:
receive one or more input parameters;
in dependence on the one or more input parameters, determine a timing delay for the torque intervention signal; and
in dependence on the determined timing delay, delay outputting of the torque intervention signal to improve alignment of the combined torque intervention from the two actuators.

2. The control system of claim 1, wherein the timing delay is determined to cause the torque intervention from the two actuators to occur at substantially the same time.

3. The control system of claim 2, wherein substantially the same time means torque intervention from the two actuators occurs within 0.0001 to 0.1 seconds of each other.

4. The control system of claim 1, wherein the one or more input parameters comprises a combined intervention request signal.

5. The control system of claim 1, wherein the one or more input parameters comprises:
a first actuator torque intervention request dependent at least upon a gear change signal; and
a second actuator torque intervention request dependent at least upon the gear change signal.

6. The control system of claim 1, wherein the delayed torque intervention signal comprises:
a delayed first actuator torque intervention request; or
a delayed second actuator torque intervention request.

7. The control system of claim 1, wherein the one or more input parameters comprises one or more delay parameters, and the control system determines the length of the timing delay to apply to the torque intervention signal in dependence upon the one or more delay parameters.

8. The control system of claim 7, wherein the one or more delay parameters comprises one or both of: engine fuelling state data and engine speed data.

9. The control system of claim 7, wherein the one or more delay parameters comprises data relating to an intervention type determined by the control system in accordance with the gear change signal.

10. The control system of claim 7, wherein the one or more delay parameters comprises one or more of: real time-data and stored data.

11. The control system of claim 7, wherein the control system is arranged to determine, for each of the two actuators, a total path delay in dependence upon one or more of the one or more delay parameters, the total path delay representing a time period from the control system outputting a torque intervention request for that actuator to deliver torque to an actual delivery of the requested torque; and wherein the timing delay is applied to the torque intervention signal for the actuator with the shorter total path delay to cause the torque intervention from the two actuators to occur at substantially the same time.

12. A system comprising the control system of claim 1 and a first actuator and a second actuator.

13. A vehicle comprising the control system of claim 1.

14. A method for controlling a combined torque intervention of two actuators to a transmission system of a vehicle, the method comprising:
receiving a gear change signal that is indicative of a requirement to perform a gearshift and output a torque intervention signal that requests part of the combined torque intervention from a first one of the two actuators in response to the received gear change signal;
receiving one or more input parameters;
in dependence on the one or more input parameters, determining a timing delay for a torque intervention signal that requests part of the combined torque intervention from a first one of the two actuators; and
in dependence on the determined timing delay, delay outputting the torque intervention signal to improve alignment of the combined torque intervention from the two actuators.

15. Computer readable instructions which, when executed by a computer, are arranged to perform a method according to claim 14.
